(19) United States
(12) Patent Application Publication
(10) Pub. No.: US 2008/0126481 A1
(43) Pub. Date: May 29, 2008

(54) METHOD AND SYSTEM FOR PROVIDING COMMUNICATION CONTEXT SPECIFIC FORMALITY CONTROL

(76) Inventors: Al Chakra, Cary, NC (US); Jonathan P. Thomson, Salem, MA (US); Patrick Joseph O'Sullivan, Dublin (IE); Sean Callanan, Dublin (IE)

Correspondence Address: LOTUS AND RATIONAL SOFTWARE;David A. Dagg, Esq., 44 Chapin Road, Newton, MA, 02459, US

(21) Appl. No.: 11/563,208

(22) Filed: Nov. 26, 2006

(51) Int. Cl. G06F 15/16

(52) U.S. Cl. 709/204

(57) ABSTRACT

A system for automatically providing different levels of formality controls in a communication is disclosed, in which a formality level is determined based on a current communication context. The formality level is used to enable an appropriate level of automatic checking of the communication contents. The determination of a formality level for a communication may be based on any specific context information regarding the participants and/or contents of a communication. including but not limited to the relative positions of participants within an organizational hierarchy (“organizational distance”), the professional relationships of the participants (e.g. service provider to client/customer), the frequency of communications between participants, the geographic locations of participants, the number of previous errors in the communication contents, configurable participant preferences, express communication settings by participants, etc. The determined formality level may be used to enable any specific type or level of automatic message contents checking, including but not limited to various types and levels of spell checking (e.g. location specific spell checking), grammar checking, acronym substitution, cultural filtering, etc. The disclosed system may determine organisational distances based on the contents of user directories, such as lightweight directory access protocol (LDAP) directories.

### FIELD OF THE INVENTION

The present invention relates generally to formality checking and controls in computer communication systems, and more specifically to a method and system for automatically providing different levels of formality controls depending on a current communication context.

### BACKGROUND OF THE INVENTION

Today's businesses use many specific types of internal and external communication technologies for collaboration, decision-making, and communication. Both synchronous and asynchronous communication applications are used in this regard. Synchronous communication systems require that participants be on-line simultaneously, in order to concurrently participate in a real-time communication session. One popular form of synchronous communication is instant messaging. Instant messaging technology can be used to make multiple users immediately available for queries at a moment's notice. Some examples of IM systems include AOL's (America Online®) Instant Messenger (AIM), IBM Lotus® SameTime®, Microsoft®'s MSN Messenger/Windows Messenger, and Yahoo!'s Messenger. Asynchronous communication systems operate by allowing a user to send a message to a recipient regardless of whether the recipient is currently on-line. The message is then stored, for example on a server system, until the recipient decides to open it, at which point it is forwarded to the recipient. The most common form of asynchronous communication application is electronic mail (“e-mail”). Examples of existing e-mail systems include Web applications that allow users to access their e-mail through a Web browser program, such as MSN Hotmail®, Yahoo! Mail, and Google®'s Gmail, as well as systems that use an e-mail specific client program, such as Microsoft® Outlook, Mozilla Thunderbird and Eudora.

The increasing use of communication technologies is changing conventional behavior in terms of who talks to who. Even some of the most vertically organized corporations are becoming relatively flat in terms of lines of communication. It is no longer uncommon for an executive to have a direct instant messaging session with an engineer, potentially asking technical questions about a specific product. In such a relatively “vertical” communication, the answers provided by the engineer should be precise, focused, and error-free, in order to help the executive make whatever decision he/she is making. Mistakes resulting from excessive informality, such as typographical and grammatical errors, could result in ambiguity or a misstatement, but not be noticed and/or corrected by the engineer when sending a message. Such errors could easily go undetected by the executive, inadvertently causing a misunderstanding in the executive's mind, with significantly costly results.

Vertical communications within an organization are one example of a communication context that creates a dilemma, in that the communication's quality may not be as high as its speed. Unfortunately, existing systems do not distinguish between communication contexts in which the content of a communication should be relatively clear (or correct), and those in which communication contents can be more casual. Existing systems accordingly fail to recognize that it would be acceptable for communications in certain contexts, such as those between the engineer and the executive, to be less speedy, if the loss in speed resulted in more clarity and correctness in the communication contents. As a corollary, communications in other contexts, such as between frequently communicating peer users, need not be as concerned with high levels of clarity and correctness. This reflects the fact that some communications are more important or critical than others, and that communication contents are subjectively interpreted in the minds of participants based on their shared knowledge (or lack thereof). Accordingly, a communication session between frequently communicating peers may be conducted in a less formal way, with relatively less risk of misunderstanding, since that communication is performed in a context that includes a relatively high amount of shared knowledge. In contrast, in a communication session with a high ranking executive, important customer, etc., a user may prefer to spend time eliminating spelling or grammar mistakes, so as to achieve greater precision (and professionalism) in the message contents. Such “high-formality” communication sessions would therefore be more likely to benefit from relatively high levels of automated checking of the message contents before the message is sent.

For the above reasons and others, it would be desirable to have a new system for determining a communication context for a communication, for determining a formality level for the communication based on the communication context, and for enabling a level of automated checking of communication contents in response to the formality level of the communication.

### SUMMARY OF THE INVENTION

To address the above described and other shortcomings of the prior art, a method and system for automatically providing different levels of formality control in a communication is disclosed, in which a formality level is determined based on a current communication context. The determined formality level is used to enable an appropriate level of automatic checking of the communication contents. The determination of a formality level for a communication may be based on any specific context information regarding the participants and/or contents of a communication, including but not limited to the relative positions of participants within an organizational hierarchy (“organizational distance”), the professional relationships of the participants (e.g. service provider to client/customer), the frequency of communications between participants, the geographic locations of participants, the number of previous errors in the communication contents, configurable participant preferences, express communication settings by participants, etc. The determined formality level may be used to enable any specific type or level of automatic message contents checking, including but not limited to various types and levels of spell checking (e.g. location specific spell checking), grammar checking, style checking, acronym substitution, location specific cultural filtering, etc.

The disclosed system advantageously operates to reduce user frustration resulting from miscommunication and/or excessive time needed to decipher poorly written communications due to the high speed at which messages are often composed. In one embodiment, the disclosed system determines organizational distances based on the contents of user directories, such as lightweight directory access protocol (LDAP) directories, but any specific type of user directory may be used in the alternative. Using the disclosed system, an auto-correction level or the like can be automatically set based on the user directory information for individual(s) to which a communication is to be directed. Those skilled in the art will recognize that the disclosed system is not limited to any specific type of auto-checking or auto-correction, but may be embodied to provide varying levels of various types of auto-checking and/or auto-correction based on the formality level determined for the communication.

Thus there is disclosed a new system for determining a communication context for a communication, and for determining a formality level for the communication based on the communication context. The disclosed system enables a level of automated checking of communication contents in response to the determined formality level of the communication.

### BRIEF DESCRIPTION OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings in which:

FIG. 1 is a block diagram showing software and hardware components in an illustrative embodiment of the disclosed system;

FIG. 2 is a block diagram showing operation of software components in an illustrative embodiment of the disclosed system;

FIG. 3 is a flow chart showing steps performed by an illustrative embodiment of the disclosed system; and

FIG. 4 is a simplified screen shot showing display objects generated during operation of an illustrative embodiment of the disclosed system.

### DETAILED DESCRIPTION OF EXEMPLARY EMBODIMENTS

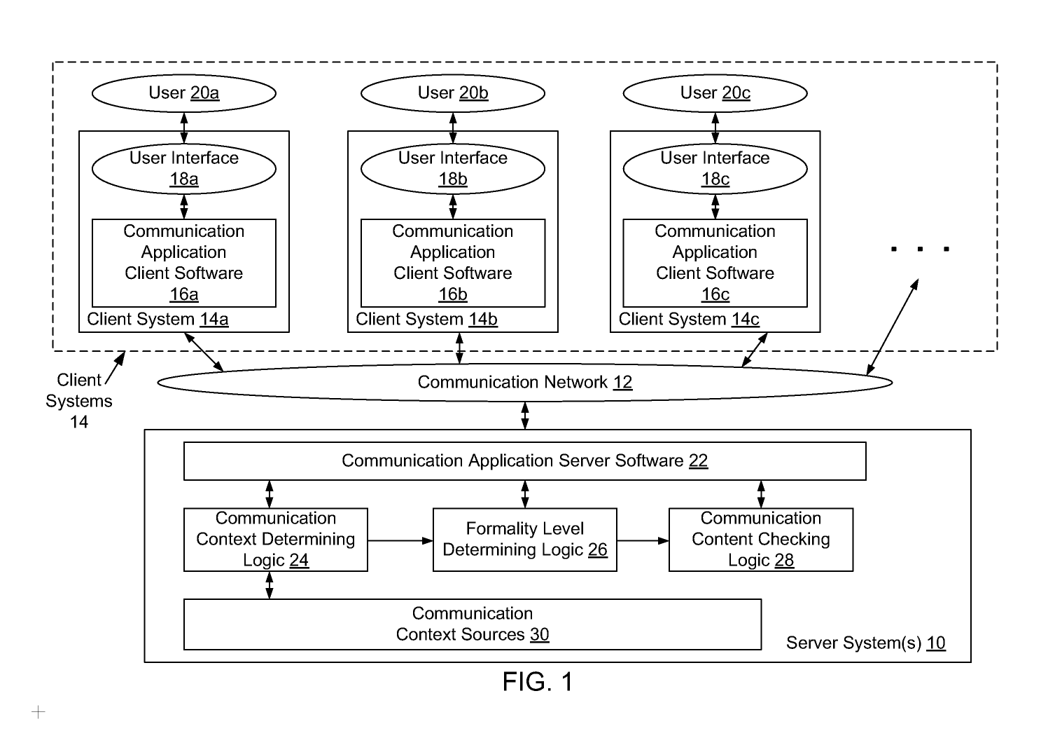

As shown in FIG. 1, software components in an operational environment including an illustrative embodiment of the disclosed system include server system(s) 10, communication network 12, and client systems 14. The server system(s) 10 is shown including communication application server software 22, together with communication context determining logic 24, formality level determining logic 26, communication content checking logic 28, and communication context sources 30. The client systems 14 include a number of specific client systems, shown for purposes of illustration as including client systems 14a, 14b, 14c, etc. Each of the client systems 14 includes communication application client software, shown as client software 16a, 16b, 16c, etc., which generates a user interface to the communication system provided by the communication application server software 22, and shown as user interfaces 18a, 18b, and 18c. The user interfaces in the client systems 14 may be navigated using any specific type of user interface device, such as a computer keyboard or mouse, and/or using voice commands or the like. Each of the client systems 14 is accessible to and used by a corresponding user or users, shown as users 20a, 20b and 20c.

The server system(s) 10 may be embodied as any specific number of software processes and/or components executing on one ore more computer systems that are communicably connected. Such computer systems may, for example, each consist of at least one processor, program storage, such as memory, for storing program code executable on the processor, one or more input/output devices and/or interfaces, such as data communication and/or peripheral devices and/or interfaces, and may each further include appropriate operating system software. Similarly, the client systems 14 may include any specific type of computer system or other type of client device, such as, for example, desktop computer systems, PDAs (Personal Digital Assistants), cell phones, tablet PCs, or any other appropriate device capable of providing user interfaces to a user. The communication network 12 through which are connected the server system(s) 10 and the client systems 14 may include or be made up of a data communication network, such as the Internet, a Local Area Network (LAN), or any other specific type of communication system or network.

While a client-server embodiment is shown in FIG. 1, in which the user interface 18 is provided by a separate client system 14 from the server system(s) 10, the disclosed system is not so limited. Alternatively, a peer-to-peer type system architecture may be used to embody the disclosed system. Accordingly, alternative embodiments may include software corresponding to the communication application server software 22, communication context determining logic 24, formality level determining logic 26, communication content checking logic 28, and/or communication context sources 30, as well as software corresponding to the client software 16a, 16b, and 16c, within peer devices operating in a peer to peer fashion.

The user interfaces 18a, 18b, 18c, may be embodied as any specific type of user interface. For example, in one embodiment, the client software 16a, 16b, 16c, etc., may be made up of Web browser programs operable to present Web pages received from the communication network to a user through a multi-window graphical user interface.

The communication application server software 22 may be embodied as any specific communication application that operates at least in part by conveying digitized content between users. For example, the server software 22 may provide a synchronous communication system through which users simultaneously participate in real-time communication sessions. Examples of synchronous communication systems that may be provided through the server software 22 include instant messaging (chat), Web conferences, electronic meetings, and others. The server software 22 may alternatively be embodied to provide an asynchronous communication system through which users send or post messages for receipt by other users regardless of whether the eventual recipients are currently on-line. In such an embodiment, the messages would be stored or posted until the recipient user(s) decide to open or read the message contents. Examples of asynchronous communication systems that may be provided through the server software include electronic mail (“e-mail”), on-line discussion forums, and others.

As illustrated in FIG. 1, during operation of an embodiment of the disclosed system, the communication context determining software logic 24 obtains context information from the communication context sources 30. For example, the communication context determining logic 24 may operate to determine a current communication context at a time when a user enters a communication session provided by a synchronous communication system, when a user composes a message to be entered into a synchronous communication session, or when a user composes a message to be sent through a asynchronous communication system. The current communication context may subsequently updated periodically, and/or in response to other triggering events.

The communication context sources 30 may include any specific type of information relating to a current communication, including information databases describing an organizational hierarchy to which communication participants belong, and from which an “organizational distance” can be determined between communication participants. For example, the communication context sources may include an LDAP (Lightweight Directory Access Protocol) directory with entries for the communication participants, and having a hierarchical structure indicating a distance between the communication participants that reflects the different levels in a corresponding organization hierarchy at which the participants are located. An example of an organizational hierarchy would be a tree structure, in which those members of an organization that are executives (e.g. officers of the company such as Chief Executive Officer (CEO), Chief Technical Officer (CTO), etc.) and the like are represented by entries located at higher levels of the tree, while relatively lower level members of the organization (e.g. junior engineers, junior sales representatives, etc.), are located by entries at relatively lower levels of the tree. In such a case, the organizational distance between two organization members may be determined by an embodiment of the disclosed system to be the number of levels in the tree between the two members.

A user profile database associated with the server software 22 may also be one of the communication context sources 30, and include user profile entries indicating the professional relationships of the communication participants. Such professional relationships may indicate whether one of the communication participants is a customer or client of another participant, who may be service provider, seller of goods, etc.

A log of previous communications using the server software 22 may also be one of the communication context sources 30. Such a log would indicate the frequency of previous communications between participants in the current communication. Information describing the geographic locations of communication participants may also be included in the communication context sources 30. For example, such geographic location information may be determined based on the IP (Internet Protocol) addresses used by corresponding communication participants, and/or through information stored in their profile entries in a user profile database. A log of a current communication session may further be contained within the communication context sources 30, indicating a number of previous spelling, grammatical, or other types of content errors detected in previously entered contents of a current communication session between the participants. The communication context sources 30 may further indicate configured participant preferences, for example within a user profile database, and/or communication settings expressly entered by participants when entering a current communication session, for example through the user interfaces 18a, 18b, 18c, etc.

Further during operation of the embodiment of the disclosed system shown in FIG. 1, the communication context determining logic 24 passes indication(s) of the current communication context to the formality level determining logic 26, which operates to determine a formality level based on the current communication context. The determined formality level is then passed to the communication content checking logic 28 to control the level of automatic checking that is performed on the communication. Examples of the types of automatic checking performed in response to the specific formality level for a communication include various types and levels of spell checking (e.g. location specific spell checking), grammar checking, style checking, acronym substitution, location specific cultural filtering, etc.

For example, in response to a determination that an organization distance between a first participant and a second participant exceeds a threshold, and the second participant is relatively higher in the organization hierarchy than the first participant, the formality level determining logic would determine a formality level that raises the amount of checking (e.g. spell checking, grammar checking, style checking, acronym substitution, etc.) automatically performed by the communication content checking logic 28 on communication content generated by the first participant, prior to that content being communicated to the second participant through the server software 22.

In another example, in response to a determination that a professional relationship between a first participant and a second participant is of a certain type, e.g. the second participant is a client or customer of the first participant or an organization to which the first participant belongs, the formality level determining logic 26 would also determine a formality level that raises the amount of checking automatically performed by the communication content checking logic 28 on communication content generated by the first participant, prior to that content being communicated to the second participant through the server software 22.

In another example, in response to a determination that the frequency of previous communications between a first participant and a second participant exceeds a threshold, the formality level determining logic 26 would determine a formality level that lowers the amount of checking automatically performed by the communication content checking logic on communication content generated by the first participant, prior to that content being communicated to the second participant through the server software 22.

In another example, in response to a determination that a geographic location of a participant matches a location for which one or more location specific automatic checking processes are available within the communication content checking logic 28, the formality level determining logic 26 would determine a formality level that causes those location specific automatic checking processes to be applied to the contents of a communication that participant, prior to delivery of the content to that participant by the server software 22. For example, such location specific automatic checking processes may include location specific spell check processes, location specific cultural filters, and others. Location specific cultural filters may, for example, detect parts of communication content that may be offensive or inappropriate for use with participants in certain locations, and flag such content for change or correction before being communicated by the server software 22. Examples of offensive or inappropriate communication content might include the use of text in certain colors that may be known to be offensive to participants in certain locations, use of offensive phrases, or other aspects of communication content.

In another example, in response to a determination that a number of previous spelling, grammatical, or other types of content errors in previous communications from a first participant in a current or previous communication session exceeds a threshold, then the formality level determining logic 26 would determine a formality level that lowers the amount of checking automatically performed by the communication content checking logic on communication content generated by one or more other communication session participants, prior to that content being communicated to the first participant through the server software 22.

In another example, the formality level determined by the disclosed system would raise or lower the amount of checking automatically performed by the communication content checking logic 28 in response to configured communication participant preferences and/or communication settings expressly entered by the participants.

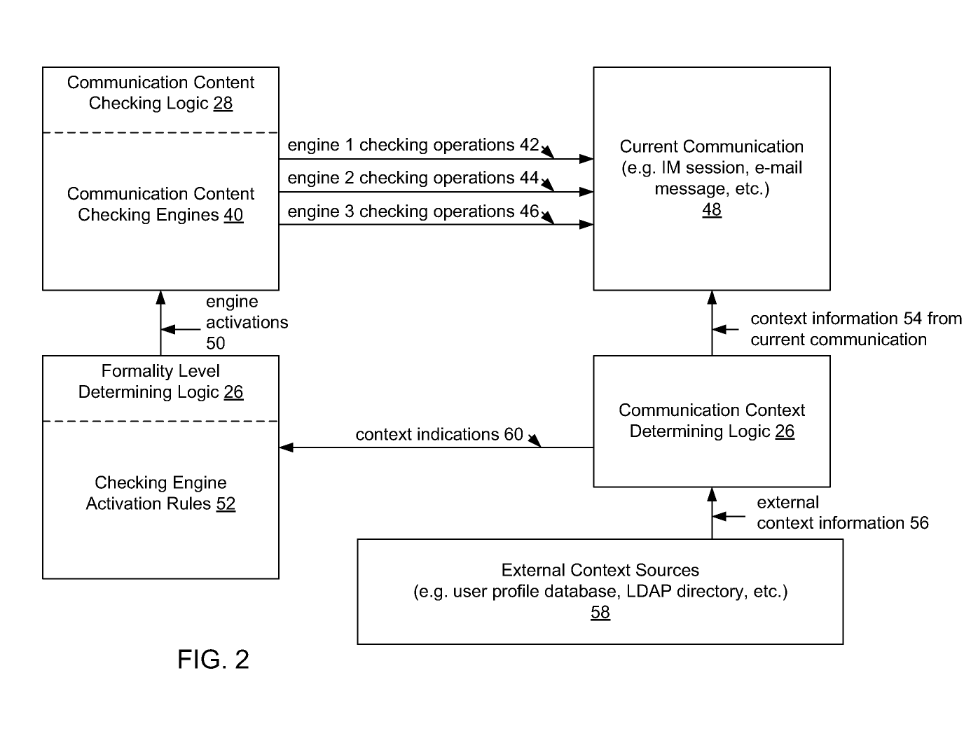

FIG. 2 is a block diagram showing operation of software components in an illustrative embodiment of the disclosed system. In the embodiment, of FIG. 6, the communication content checking logic 28 of FIG. 1 includes a number of communication content checking engines 40, each of which includes software operable to perform operations on the content of a current communication 48. The current communication 48 may, for example, consist of text or other contents to be added to an instant messaging session, text or other content that is part of an e-mail message that is to be sent, etc. The communication content checking engines 40 may, for example, include program code operable to perform spell checking, grammar checking, style checking, acronym substitution, cultural filtering, etc.

Individual ones of the communication content checking engines 40 are enabled to check the current communication 48 through the engine activations 50 provided from the formality level determining logic 26 of FIG. 1. Operations performed by enabled ones of the communication content checking engines 40 are illustrated in FIG. 2 by engine 1 checking operations 42, engine 2 checking operations 44, engine 3 checking operations 46, etc.

Further in the example embodiment of FIG. 2, the engine activations 50 are provided based on the evaluation of checking engine activation rules 52 in the formality level determining logic 26. The checking engine activation rules 52 indicate which of the communication content checking engines are to be enabled in response to specific communication contexts, as provided in the embodiment of FIG. 2 from the communication context determining logic 26 in the form of context indications 60. In one embodiment, a relatively higher level of formality causes a relatively higher number of checking engines to be activated. Accordingly, in such an embodiment, a first formality level might cause a checking engine to be activated that performs spell checking, while a relatively higher formality level might also cause a checking engine to be activated that performs grammar checking. A next higher formality level might also cause a checking engine to be additionally activated that performs acronym substitution, a still higher formality level might cause a checking engine to be activated that performs style checking, an even higher formality level might additionally cause a checking engine to be activated that performs cultural filtering, and so on.

The context indications 60 are generated by the communication context determining logic 26 based on the context information 54 from the current communication determined from previous content entered into the current communication 48, and also on external context information 56 obtained from the external context sources 58. Context information 54 may, for example, include information describing the number of mistakes previously made in the current communication session, IP addresses of participants in the current communication session, and/or other information from the current communication session. Context information 56 may, for example, include information obtained from a user profile database, LDAP directory, or other external context source.

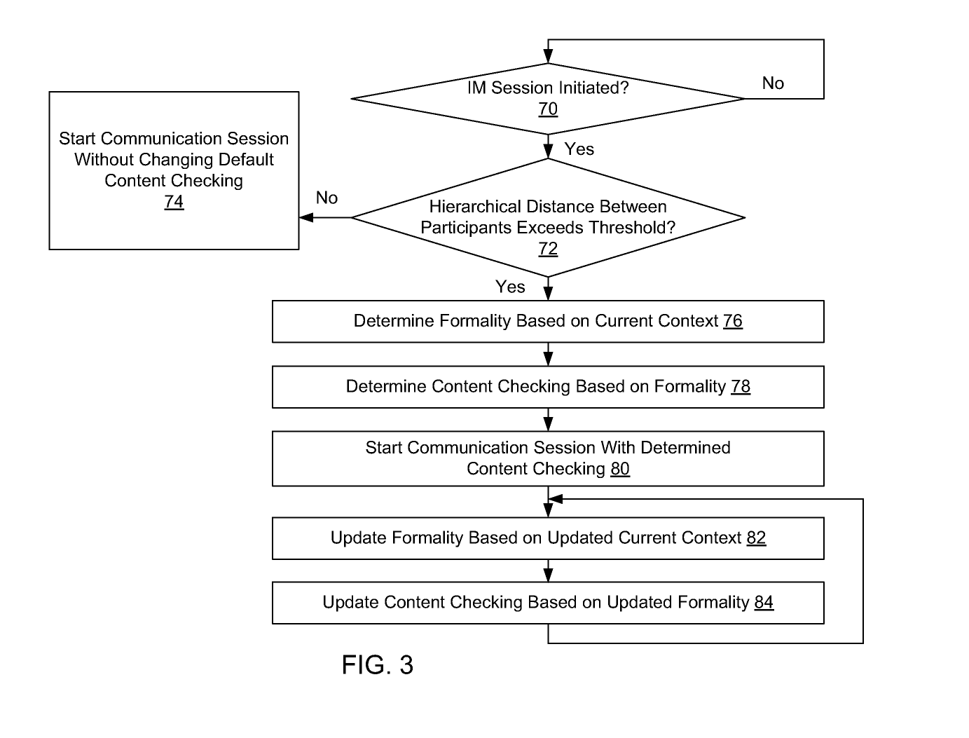

FIG. 3 is a flow chart showing steps performed by an illustrative embodiment of the disclosed system for an instant messaging system, and in which formality for a communication session is determined based on organization distance between participants as indicated by the contents of an LDAP directory. As shown in FIG. 3, the embodiment of the disclosed system operates in response to a determination that an instant messaging session has been initiated. When an instant messaging session is initiated, step 70 is followed by step 72, in which a determination is made as to the organization distance between a participant joining the session and one or more other participants in the session that are higher in the organizational hierarchy than the joining user.

For example, if a user is joining an instant messaging session in which multiple other users are already participating, then at step 72 the embodiment of the disclosed system shown in FIG. 3 determines an organizational distance that is the maximum organizational distance between the joining user and any one of the other users currently participating in the communication session that is at a higher organizational level than the joining user. This approach ensures that the formality level selected for a user joining a chat session with multiple other users is as high as needed to match the formality appropriate for the participant that is most above the joining user in the organizational hierarchy. As a result, if a relatively junior engineer in a company joins an instant messaging session in which several other junior engineers are participating, and in which one vice president of the company is also participating, then the formality level for the junior engineer joining the session is set high enough to enable automatic checking engines or the like sufficient to make the contents entered by the junior engineer clear and accurate for consumption by the vice president. Additionally, the determination of hierarchical distance made at step 72 may be updated as new participants are added to the session, in order to adjust the formality level when a new participant is relatively higher in the organizational hierarchy than the previously highest level participant. Similarly, the hierarchical distance determined at step 72 may be updated as participants leave the session, to adjust the formality level when a highest level participant in the organizational hierarchy exits the session.

If the hierarchical distance determined at step 72 exceeds a predetermined threshold, then step 72 is followed by step 76. Otherwise, step 72 is followed by step 74, in which the instant messaging communication session is started without changing the current or default amount of automatic content checking.

At step 76, the disclosed system determines a formality level based on the current communication context. In the embodiment of FIG. 3, the formality level is determined based on the hierarchical distance in the organizational hierarchy to which the communication session participants belong, as determined at step 72. Next, at step 78, the disclosed system determines the automatic content checking to be provided to the user joining the communication session, based on the formality level determined at step 76.

At step 80, the instant messaging communication session is started with the automatic content checking functions determined at step 78. The formality level is subsequently updated based on the updated current communication context at step 82. Updated communication context may be based on the content of the communication session itself as the chat session goes on, and/or updated information from external communication context sources. At step 84, the level of automated content checking is updated based on the updated formality level. The updating performed in steps 82 and 84 may be repeated periodically, or in response to one or more trigger events, such as when users join or leave the communication session.

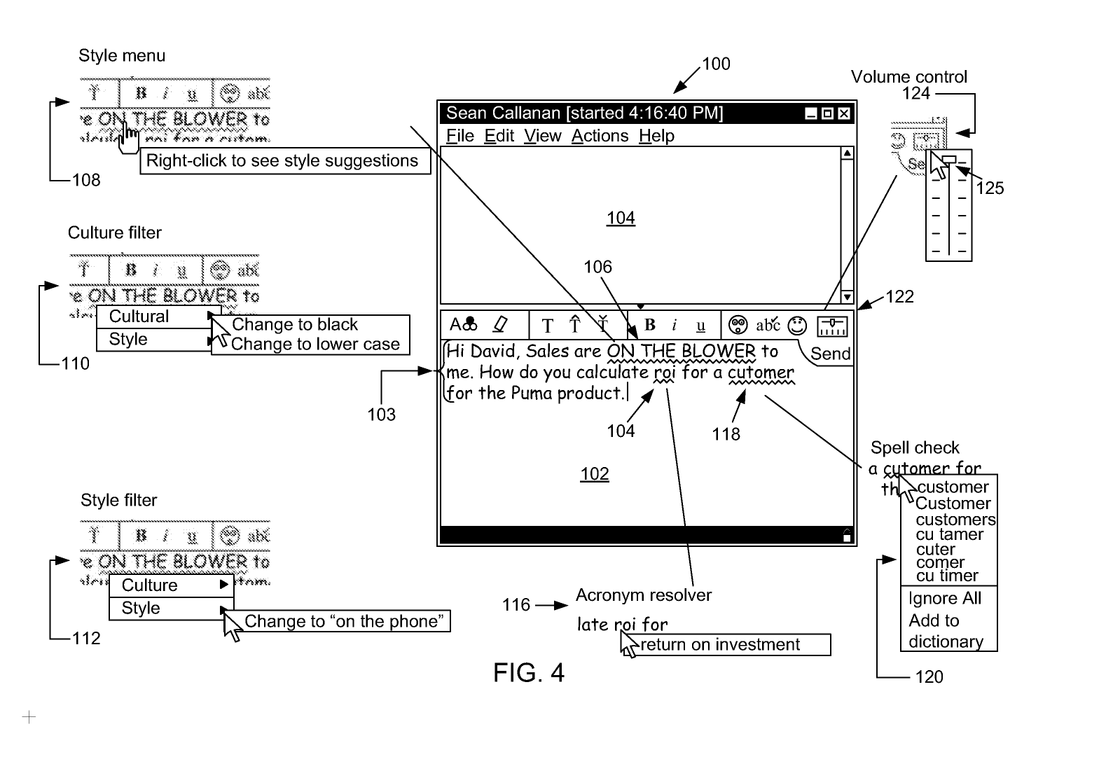

FIG. 4 is a simplified screen shot showing display objects generated during operation of an illustrative embodiment of the disclosed system. The display objects shown in FIG. 4 may be embodied as what are commonly referred to as “widgets”. As it is generally known, “widget” is a generic term for a portion of a graphical user interface (GUI) that allows the user to interface with an application and operating system. Widgets such as the display objects of FIG. 4, are used to display information to the user, and typically invite the user to perform an action. The display objects of FIG. 4 may, for example, be provided in one of the user interfaces 18a, 18b, 18c, etc. shown in FIG. 1. In one embodiment, the display objects of FIG. 4 are generated by corresponding checking engines that are enabled in the communication content checking logic 28 shown in FIGS. 1 and 2.

As shown in the embodiment of FIG. 4, an instant messaging user interface window 100 includes a session portion 104 in which the contents of an instant messaging session are displayed. A message composition portion 102 enables the user to compose a message to be added to the session. In the example of FIG. 4, the user has entered text 103 into the message composition portion 102 of the window 100. Various content checking engines within the communication content checking logic 28 of FIGS. 1 and 2 have been enabled in response to a previously determined formality level for the instant messaging session taking place in the session portion 104 of the window 100. As a result, checking operations have been performed on the text 103 prior to it being entered into the instant messaging session, enabling the user to correct and clarify the text before entering it. The checking operations have flagged portions of the text 103 (e.g. by underlining, highlighting, bolding or other visual indications), and the flagged portions of the text can be clicked on by the user in order to access suggested change options provided by the corresponding checking engines.

For example, the text “ON THE BLOWER” 106 has been flagged by underlining. In the example of FIG. 4, the text “ON THE BLOWER” 106 has been identified as being a phrase that may not be understood by another participant in the communication session based on its style, and which may offend the cultural sensibility of the same or a different other participant in the communication session, based on the fact that it is in all upper case, and/or the fact that it is in a color, e.g. red, that may be culturally offensive to that participant, for example as determined based on their geographic location.

If the user clicks on the text 106, the user is presented with the display object 108, which provides a top level style menu. The disclosed system enables the user to right click on the display object 108 in order to obtain the culture filter display object 110, which in turn enables the user to select between cultural and style related suggestions for changing the text 106. In the example of FIG. 4, in the cultural filter related suggestions provided through the display object 110, the user can select between changing the color of the text 106 from its current color (non-black) to black, and/or changing the text 106 from all upper case to all lower case. The suggested change in color and/or change to lower case are intended to improve the message contents in terms of the cultural sensibilities of one or more other participants in the communication session.

The style filter display object 112 is generated when the user hovers the cursor over the “style” menu option in the display object 110, and enables the user to change the text 106 to the phrase “on the phone”, which is intended to clarify the meaning of the message contents to one or more other participants in the communication session.

The text “roi” 114 has also been flagged in the text 103, again by underlining. The user can click on the text 114 to be provided with the acronym resolver display object 116. The display object 116 enables the user to select a suggested change to the acronym “roi” to its full spelling of “return on investment”. The suggested change provided by the display object 116 is intended to reduce the likelihood of misunderstanding by one or more other participants in the communication session.

The text “cutomer” 118 has also been flagged in the text 103, again by underlining, as a misspelled word. The user can click on the text 118 to be provided with the spell check display object 120, which provides a list of possible words that could be substituted for the text 118. The user can select one of the words provided in the list within the display object 120 to correct the spelling of “cutomer”. The suggested changes provided by the display object 120 are intended to reduce the informality of the text 113, and improve its correctness, before it is added to communication session.

A formality volume control button 122 is provided within the window 100, to allow the user to increase or lower the formality level associated with the communication session. In response to the user clicking on the volume control button 122, the disclosed system provides the volume control display object 124. The volume control display object 124 enables the user to increase the formality level associated with the communication session, e.g. by raising a sliding bar display object 125. The volume control display object 124 further enables the user to decrease the formality level associated with the communication session, e.g. by lowering the sliding bar display object 125. The volume control display object 124 is one example of how the present system can be embodied to allow a user to expressly control the formality level of a given communication session through a user interface provided to that communication session. A formality level change made by the user through the volume control display object 124 causes the amount of automatic checking performed on the communication session to be adjusted to match the new formality level.

The present invention can be realized in hardware, software, or a combination of hardware and software. A system according to the present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software could be a general purpose computer system with a computer program that, when being loaded and executed, controls the computer system such that it carries out the methods described herein.

The figures include block diagram and flowchart illustrations of methods, apparatus(s) and computer program products according to an embodiment of the invention. It will be understood that each block in such figures, and combinations of these blocks, can be implemented by computer program instructions. These computer program instructions may be loaded onto a computer or other programmable data processing apparatus to produce a machine, such that the instructions which execute on the computer or other programmable data processing apparatus create means for implementing the functions specified in the block or blocks. These computer program instructions may also be stored in a computer-readable medium or memory that can direct a computer or other programmable data processing apparatus to function in a particular manner, such that the instructions stored in the computer-readable medium or memory produce an article of manufacture including instruction means which implement the function specified in the block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the block or blocks.

Those skilled in the art should readily appreciate that programs defining the functions of the present invention can be delivered to a computer in many forms; including, but not limited to: (a) information permanently stored on non-writable storage media (e.g. read only memory devices within a computer such as ROM or CD-ROM disks readable by a computer I/O attachment); (b) information alterably stored on writable storage media (e.g. floppy disks and hard drives); or (c) information conveyed to a computer through communication media for example using wireless, baseband signaling or broadband signaling techniques, including carrier wave signaling techniques, such as over computer or telephone networks via a modem.

While the invention is described through the above exemplary embodiments, it will be understood by those of ordinary skill in the art that modification to and variation of the illustrated embodiments may be made without departing from the inventive concepts herein disclosed.

We claim:

1. A method for providing different levels of checking in a communications system, comprising:
determining a context of a communication;
determining a formality level for said communication based on said context of said communication; and
determining a level of automatic checking to be applied to contents of said communication based on said formality level for said communication, wherein said level of automatic checking is set relatively higher in response to relatively higher formality levels, and wherein said level of automatic checking is set relatively lower in response to relatively lower formality levels.

2. The method of claim 1, further comprising:
wherein said context of said communication includes an organizational hierarchy of an organization to which participants in said communication belong;
wherein said determining said formality level for said communication is responsive to said organizational hierarchy, such that a relatively greater distance between said participants in said organizational hierarchy results in a relatively higher formality level; and
wherein said determining said level of automatic checking determines a relatively higher amount of automatic checking to be applied to said contents of said communication in response to said relatively higher formality level.

3. The method of claim 2, wherein said organizational hierarchy is described in a database of user profiles for participants in said communication.

4. The method of claim 3, wherein said database comprises a light weight data access protocol database.

5. The method of claim 1, further comprising:
wherein said context of said communication includes professional relationships between participants in said communication; and
wherein said determining said formality level for said communication is responsive to said professional relationships between said participants in said communication.

6. The method of claim 1, further comprising:
wherein one of said professional relationships between said participants in said communication indicates that one of said participants is a customer of another one of said participants;
wherein said determining said formality level for said communication is responsive to professional relationship indicating that one of said participants is a customer of another one of said participants, such that profession relationship indicating that one of said participant is a customer of another one of said participants results in a relatively higher formality level; and
wherein said determining said level of automatic checking determines a relatively higher amount of automatic checking to be applied to said contents of said communication in response to said relatively higher formality level.

7. The method of claim 1, further comprising:
wherein said context of said communication includes a frequency with which participants in said communication have previously communicated;
wherein said determining said formality level for said communication is responsive to said frequency with which said participants in said communication have previously communicated, such that a relatively higher frequency of previous communications between said participants results in a relatively lower formality level; and
wherein said determining said level of automatic checking determines a relatively lower amount of automatic checking to be applied to said contents of said communication in response to said relatively lower formality level.

8. The method of claim 1, further comprising:
wherein said context of said communication includes a count of the number of errors that have previously occurred in said communication;
wherein said determining said formality level for said communication is responsive to said count of the number of errors that have previously occurred in said communication, such that a relatively higher count of the number of errors that have previously occurred in said communication results in a relatively lower formality level; and
wherein said determining said level of automatic checking determines a relatively lower amount of automatic checking to be applied to said contents of said communication in response to said relatively lower formality level.

9. The method of claim 1, further comprising:
wherein said context of said communication includes user preferences associated with participants in said communication;
wherein said determining said formality level for said communication is responsive to said user preferences associated with said participants in said communication.

10. The method of claim 1, further comprising:
wherein said context of said communication includes user settings made by participants in said communication and associated with said communication;
wherein said determining said formality level for said communication is responsive to said user settings associated with said communication.

11. The method of claim 1, further comprising:
wherein said context of said communication includes geographic locations of participants in said communication;
wherein said determining said formality level for said communication is responsive to said geographic locations of said participants in said communication, such that said formality level indicates said geographic locations of said participants in said communication; and
wherein said determining said level of automatic checking determines at least one specific type of automatic checking to be applied to said contents of said communication in response to indication of said geographic locations of said participants by said formality level.

12. The method of claim 1, wherein said communication is a synchronous communication session.

13. The method of claim 12, wherein said synchronous communication session is an instant messaging session.

14. The method of claim 1, wherein said communication is an asynchronous communication message.

15. The method of claim 1, wherein said communication message is an e-mail message.

16. The method of claim 1, wherein said checking to be applied to said contents of said communication comprises spell checking.

17. The method of claim 1, wherein said checking to be applied to said contents of said communication comprises grammar checking.

18. The method of claim 1, wherein said checking to be applied to said contents of said communication comprises acronym substitution.

19. The method of claim 1, wherein said checking to be applied to said contents of said communication comprises cultural filtering.

20. A system including a computer readable medium, said computer readable medium having program code stored thereon for providing different levels of checking in a communications system, said program code comprising:
program code for determining a context of a communication;
program code for determining a formality level for said communication based on said context of said communication; and
program code for determining a level of automatic checking to be applied to contents of said communication based on said formality level for said communication, wherein said level of automatic checking is set relatively higher in response to relatively higher formality levels, and wherein said level of automatic checking is set relatively lower in response to relatively lower formality levels.

21. A computer program product including a computer readable medium, said computer readable medium having program code stored thereon for providing different levels of checking in a communications system, said program code comprising:
program code for determining a context of a communication;
program code for determining a formality level for said communication based on said context of said communication; and
program code for determining a level of automatic checking to be applied to contents of said communication based on said formality level for said communication, wherein said level of automatic checking is set relatively higher in response to relatively higher formality levels, and wherein said level of automatic checking is set relatively lower in response to relatively lower formality levels.

22. A computer data signal embodied in a carrier wave, said computer data signal having program code stored thereon for providing different levels of checking in a communications system, said program code comprising:
program code for determining a context of a communication;
program code for determining a formality level for said communication based on said context of said communication; and
program code for determining a level of automatic checking to be applied to contents of said communication based on said formality level for said communication, wherein said level of automatic checking is set relatively higher in response to relatively higher formality levels, and wherein said level of automatic checking is set relatively lower in response to relatively lower formality levels.

23. A system for providing different levels of checking in a communications system, comprising:
means for determining a context of a communication;
means for determining a formality level for said communication based on said context of said communication; and
means for determining a level of automatic checking to be applied to contents of said communication based on said formality level for said communication, wherein said level of automatic checking is set relatively higher in response to relatively higher formality levels, and wherein said level of automatic checking is set relatively lower in response to relatively lower formality levels.
